(19) United States
(12) Patent Application Publication
(10) Pub. No.: US 2016/0191971 A1
(43) Pub. Date: Jun. 30, 2016

(54) METHOD, APPARATUS AND SYSTEM FOR PROVIDING SUPPLEMENTAL

(71) Applicant: Ana Belen Benitez, Brooklyn, NY (US)

(72) Inventor: Ana Belen Benitez, Brooklyn, NY (US)

(21) Appl. No.: 12/998,511

(22) PCT Filed: Oct. 31, 2008
(86) PCT No.: PCT/US08/12380

§ 371 Date: Jun. 7, 2012

(51) Int. Cl. H04N 21/258; H04N 21/4722; H04N 21/81; H04N 21/8541; H04N 21/242; H04N 21/2668; H04N 21/44; H04N 21/845

(52) U.S. Cl. CPC H04N 21/25891; H04N 21/44016; H04N 21/4722; H04N 21/8456; H04N 21/8541; H04N 21/242; H04N 21/2668; H04N 21/8133

(57) ABSTRACT

Embodiments of the present invention provide methods, systems and apparatuses for providing supplemental audio/video content in, for example, a non-linear presentation. In accordance with various embodiment of the present invention, a user can seamlessly obtain, in real time, additional, supplementary content associated with a main presentation in accordance with the user's preference. For example, a main data stream including consecutive, categorized segments of content can be transmitted simultaneously with one or more complementary data streams that include supplemental content associated with the categorized segments in the main data stream. A user can then be prompted to select a complementary data stream and, in response to user-selection, the complementary data stream can be presented to the user.

### TECHNICAL FIELD

The present invention generally relates to the transmission and presentation of audio/video content, and more particularly, to methods, apparatuses and systems for transmitting and presenting audio/video content in a non-linear presentation.

### BACKGROUND

Traditional broadcast systems typically present content in a linear manner. For example, with respect to news programs, news stories are concatenated in time and are presented to viewers sequentially, with one news story beginning at the end of another news story. Although users generally are not provided with options to customize content within a linear presentation, customizing and personalizing content for users can be achieved in a limited way with existing systems. A Digital Video Recorder (DVR) is one example in which users can control presentation and ordering of downloaded content by employing controls such as “play,” “pause,” “fast forward,” and “rewind.” In addition, DVRs enable users to record and view programs automatically based on previous viewing history.

While existing systems permit some user-control over content presentation, they do not provide a convenient means for users to obtain, in real time, additional, supplementary content concerning a presentation. For example, during a news program, a user is not provided with an option to view additional content regarding topics reported in a main presentation, such as international news, sports, politics, etc., in which the user is particularly interested.

### SUMMARY

Methods, systems and apparatuses in accordance with various embodiments of the present principles address the deficiencies of the prior art by providing users with real-time access of supplementary content during a presentation.

In one embodiment of the present principles, a method for providing supplemental audio/video content in a non-linear presentation includes transmitting a main data stream including consecutive, categorized segments of content, transmitting with the main data stream at least one complementary data stream including content that is supplemental to an associated segment in the main data stream and prompting a user to select the at least one complementary data stream during presentation of the associated segment. The method can further include presenting the at least one complementary data stream in response to user-selection of the at least one complementary data stream.

In an alternate embodiment of the present principles, a system for providing supplemental audio/video content in a non-linear presentation includes a coder configured to transmit a main data stream and at least one complementary data stream and a decoder that is configured to receive the main data stream and the at least one complementary data stream, prompt a user to select at least one complementary data stream during presentation of an associated segment, and cause the presentation of the at least one complementary data stream in response to user-selection of the at least one complementary data stream. In such an embodiment, the main data stream can include consecutive, categorized segments of content and the at least one complementary data stream can include content that is supplemental to the associated segment in the main data stream.

In an alternate embodiment of the present principles, an apparatus for providing supplemental audio/video content in a non-linear presentation includes a main data generator configured to generate a data stream including consecutive, categorized segments and a complementary data module configured to generate at least one complementary data stream including content that is supplemental to an associated segment in the main data stream. In one embodiment of the above described apparatus of the present invention, the apparatus is configured to transmit the main data stream and the at least one complementary data stream for presentation to a user, such that the user is prompted to select at least one complementary data stream during presentation of the associated segment. In an alternate embodiment, the apparatus of the present invention can further include a controller configured to synchronize the transmission of the at least one complementary data stream with the transmission of the main data stream such that the start of one of the categorized segments in the main data stream coincides with the completion of the supplemental content.

In an alternate embodiment of the present principles, an apparatus for providing supplemental audio/video content in a non-linear presentation includes a decoder configured to receive a main data stream and at least one complementary data stream, prompt a user to select at least one complementary data stream during presentation of an associated segment of the main data stream, and cause the presentation of the at least one complementary data stream in response to user-selection of the at least one complementary data stream.

### BRIEF DESCRIPTION OF THE DRAWINGS

The teachings of the present invention can be readily understood by considering the following detailed description in conjunction with the accompanying drawings, in which:

FIG. 1 depicts a representation of a data stream for a linear presentation that is categorized and segmented in accordance with an embodiment of the present invention;

FIG. 2 depicts a representation of data streams for a non-linear presentation that are categorized and segmented in accordance with an alternate embodiment of the present invention; and

FIG. 3 depicts a representation of a main data stream and complementary data streams in accordance with an embodiment of the present invention;

FIG. 4 depicts a high level block diagram of a system for providing supplemental audio/video content in a non-linear presentation in accordance with an embodiment of the present invention;

FIG. 5 depicts a flow diagram of a method for providing supplemental audio/video content in a non-linear presentation in accordance with an embodiment of the present invention; and

FIG. 6 depicts an alternate representation of a main data stream and complementary data streams in accordance with an alternate embodiment of the present invention;

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION

The present principles advantageously provide a method, apparatus and systems for providing supplemental audio/video content in a non-linear presentation. Although embodiments of the present invention will be described primarily within the context of a broadcast system and coder/decoder devices, the illustrated embodiments of the present principles should not be treated as limiting the scope of the invention. It will be appreciated by those skilled in the art and informed by the teachings of the present principles that the concepts of the present principles can be advantageously applied in other audio/video presentation methods and systems. For example, the concepts of the present principles can be implemented in digital video disc player devices, satellite radio broadcasting systems, Internet multi-casting systems and other systems.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which can be substantially represented in computer readable media and so executed by a computer or processor, whether or not such computer or processor is explicitly shown.

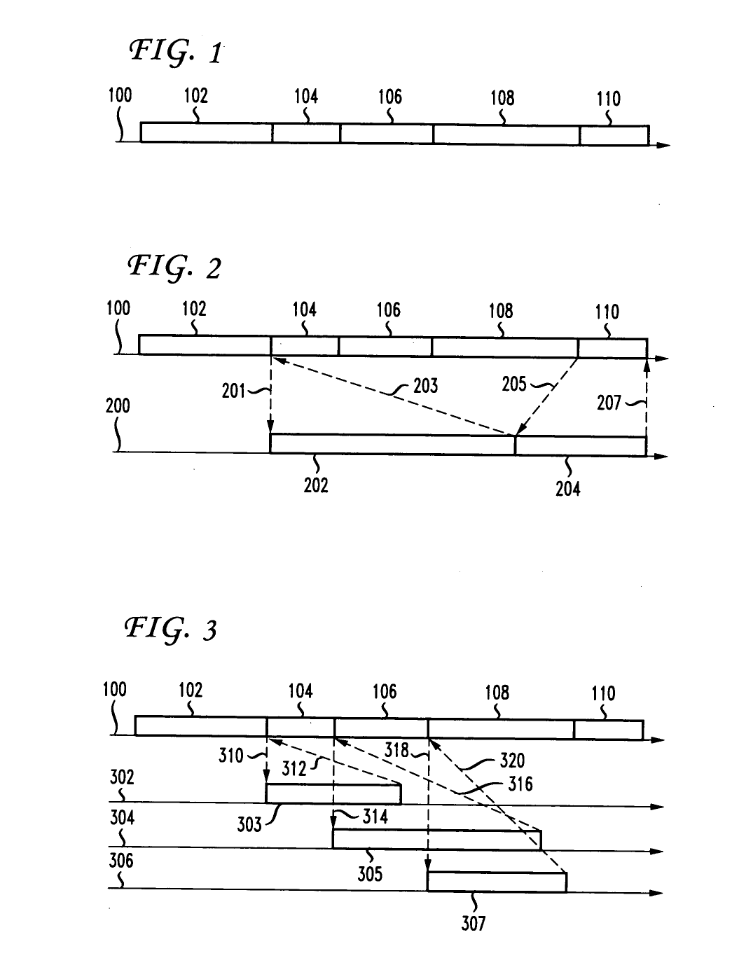

Referring now in specific detail to the drawings, and initially to FIGS. 1 and 2, exemplary data streams 100-200 for use in providing supplemental audio/video content according to one or more embodiments of the present invention are illustrated. Using the example of a news program for clarity purposes, non-linear electronic content can include multiple timelines and stories that can be joined at different points to permit audiences to watch one particular timeline and story and select another timeline and story for viewing. In this way, a user can browse the content in a non-linear manner in accordance with embodiments of the present invention.

With reference to FIGS. 1 and 2, examples of linear and non-linear presentations in accordance with one or more aspects of the present principles are respectively illustrated. The data streams 100 and 200 in FIGS. 1 and 2 are presented in the form of simultaneous timelines. FIG. 1 depicts a linear timeline for data stream 100 in which content can be segmented according to different stories and/or categories 102-110. FIG. 2 depicts a non-linear presentation, in which a first data stream 100 can be viewed in conjunction with a second data stream 200. The second data stream 200 can also include content that is segmented according to different stories and/or categories, which are represented here as segments 202 and 204. As illustrated in FIG. 2, a user can view content in a non-linear manner by switching between data streams along cross-over lines 201, 203, 205 and 207. In the example provided in FIG. 2, instead of viewing either of data streams 100 and 200 in a linear manner, a user has illustratively viewed the content segments in the data streams in the following order: 102, 202, 104, 106, 108 and 204, skipping segment 110.

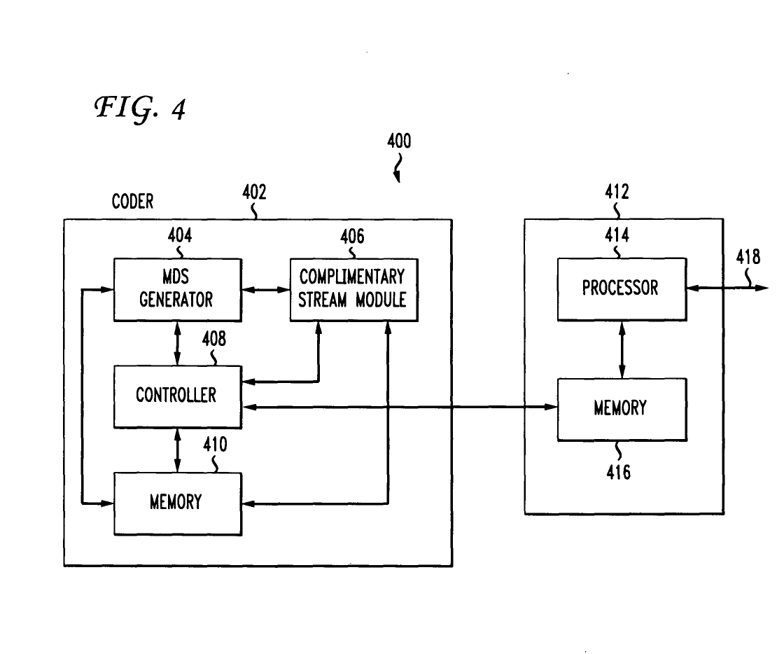

Referring to FIG. 3, according to an embodiment of the present invention, one or more complementary data streams of content can provide additional content segments that are supplemental to corresponding content segments in a main data stream. For example, complementary audio/video data streams 302, 304 and 306 can include content segments 303, 305 and 307 that are supplemental to content segments 104, 106 and 108, respectively, of a main audio/video data stream 100. Continuing with a news program model, segment 104 can correspond to an international news story and content segment 303 can include more detailed information concerning the international news story that is supplemental to the content within segment 104. Thus, upon viewing content segment 104, a user can select content segment 303 to obtain additional material for the story presented in content segment 104. As shown in FIG. 3, after viewing one or more news stories (e.g., in content segment 106) in the main data stream 100, the user can continue watching material on the same story in one of the complementary data streams (e.g., in content segment 307), or the user can move on to the next story in the main data stream (e.g., segment 108). In addition, the user can view all content segments by switching between the main data stream 100 and complementary data streams 302, 304 and 306 along cross-over lines 310-320, as illustrated in FIG. 3. Thus, in accordance with various embodiments of the present invention, a user can be provided with options to view additional content associated with principle media content topics, such as international news, sports, politics, etc., in which the user is particularly interested, for example, in real time.

FIG. 4 depicts an exemplary system 400 for providing supplemental audio/video content in a non-linear presentation in accordance with an embodiment of the present invention. System 400 can, for example, be implemented in conventional satellite, cable, and/or internet multicasting/broadcasting systems. Coder 402 and decoder 412 are illustratively included in system 400, with coder 402 located at a broadcasting site, for example, and decoder 412 located at a client site and connected to a presentation device. Coder 412 can include a main data stream (MDS) generator 404, a complementary data stream module 406, a memory means 410 and a controller 408. In one embodiment of the present invention, the main data stream generator 404, the complementary data stream module 406, and the controller 408 can be implemented in one or more processors running software within the memory 410. The main data stream generator 404 and the complementary data stream module 406 can be configured to generate a main data stream and complementary data streams, respectively, which are described above. The controller 408 can receive the data streams from the main data stream generator 404 and the complementary data stream module 406 and can be configured to prepare the data streams for simultaneous transmission to the decoder 412. For example, the controller 408 can encode the data streams and can packetize them into a transport stream. The memory 410 can be utilized by any one or more of the main data stream generator 404, the complementary data stream module 406, and the controller 408 to store the main data stream and/or the complementary data streams.

The decoder 412 can be configured to receive and decode the main data stream and the complementary data streams from the coder 402 and can include a processor 414 and a memory 416. The memory 416 can be configured to store and/or buffer the main data stream and the complementary data streams. Further, the processor 414 can cause the decoding of the main data stream and the complementary data streams and process them as described more fully below with respect to method 500. Additionally, the decoder 412 can communicate the decoded data streams, for example, along transmission line 418 to a presentation device, such as a television, a computer display and/or speakers for presentation to a user. It should be understood that although a single decoder is depicted in FIG. 4, a plurality of decoders corresponding to a plurality of clients for receiving content from one or more coders 402 can be included in system 400 in accordance with alternate embodiments of the present invention.

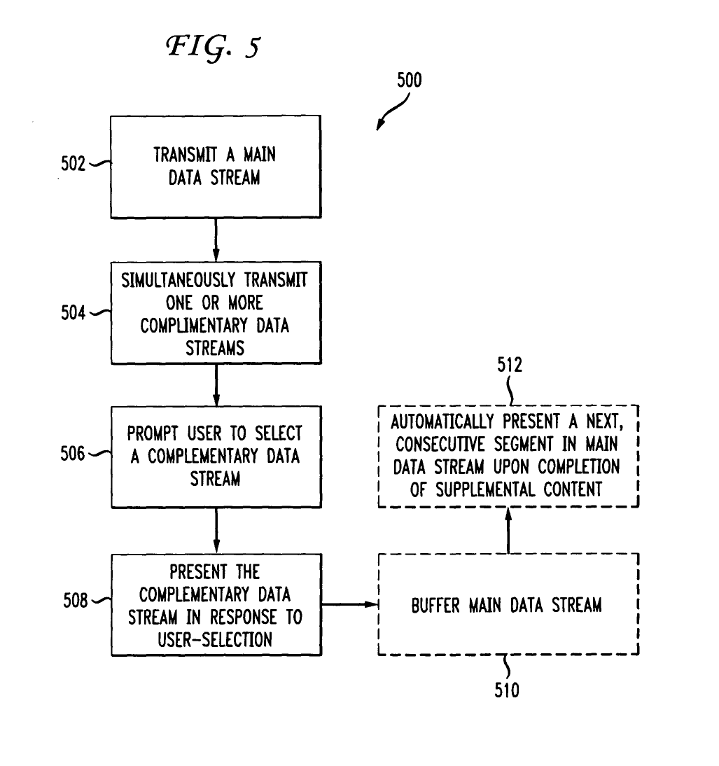

Referring to FIG. 5 with continuing reference to FIGS. 3 and 4, a high-level flow diagram depicting a method 500 for providing supplemental audio/video content in a non-linear presentation in accordance with an embodiment of the present invention is illustrated. The method 500 begins at step 502 in which a main data stream is transmitted. The main data stream can include consecutive, categorized segments of content. For example, continuing with a news program model as described above with respect to FIGS. 1-3, a main data stream can be segmented into various stories or topics corresponding to international news, sports, politics, local news, and other topics. Further, the main data stream can be generated and transmitted by coder 402, as discussed above. The method 500 then proceeds to step 504.

At step 504, one or more complimentary data streams are simultaneously transmitted with the main data stream. As discussed above with regard to FIG. 3, the complimentary data stream(s) can include content segments that are supplemental to associated content segments in a main data stream. Referring again to FIG. 3, in an exemplary implementation in conventional broadcasting or cable systems, the main data stream 100 can be transmitted and presented through channel A, while the complementary data streams 302, 304 and 306 can be simultaneously transmitted and presented through channels B, C and D, respectively. Coder 402 can, for example, be configured to generate and transmit the complementary data streams simultaneously with the main data stream. For example, the complementary data streams can be generated by the complementary data stream module 406 and the simultaneous transmission can be driven by the controller 408. The method 500 then proceeds to step 506.

At step 506, a user can be prompted to select a complimentary data stream during presentation of an associated segment within the main data stream. For example, near the end of each news story or content segment during presentation of the main data stream, the user can be prompted to select a complementary data stream by presenting the channel numbers corresponding to one or more complementary data streams including supplemental content in the display. For example, the channel number can be shown on a television screen with text indicating that supplemental content is presented on an alternate channel as follows: “For more information concerning the causes of rising fuel prices, tune to channel B.” Referring to FIG. 3, at the end of content segment 102 in the main data stream 100, for example, the user can be prompted to select data stream 302 for the display of supplementary content segment 303. Additionally, it should be understood that the decoder 412 can be configured to perform step 506. For example, the decoder 412 can receive the main data stream and the complementary data streams for presentation to a user. The processor 414, utilizing memory 416, can be configured to decode the data streams and transmit them to a presentation/display device, as discussed above. Moreover, the main data stream can be adapted to prompt a user to select at least one complementary stream during presentation of an associated segment, as stated above, for example. The method 500 then proceeds to step 508.

At step 508, the complementary data stream can be presented to a user in response to user-selection of the complementary data stream. For example, continuing with the conventional broadcasting or cable television implementation for clarity purposes, after a user is prompted to select data stream 302 for the display of supplementary content segment 303, as discussed above with respect to step 506, the user can select the complementary data stream 302 by selecting the channel prompted for seamless presentation (i.e., viewing of media and listening to audio) of the supplemental information provided in segment 303. In response to the channel selection, the channel including the complementary data stream prompted in step 506 can be presented to the user. According to one exemplary implementation, the processor 414 of the decoder 412 can be configured to perform step 508. The method 500 then proceeds to step 510.

At step 510, the main data stream can optionally be buffered during presentation of the at least one complementary data stream to permit the user to seamlessly view the main data stream upon completion of the supplemental content. For example, a decoder can be configured to continually buffer the main data stream 100 after a user has selected a complementary data stream. With reference to FIG. 3, for example, at the end of a presentation of supplementary content segment 303, the user can select the main data stream to view segment 104, which is the next, consecutive segment after segment 102 in the main data stream. Buffering of the main data stream permits seamless viewing of the next, consecutive segment in the main data stream. In one exemplary embodiment, the processor 414, utilizing the memory 416, of the decoder 412 can be configured to perform step 510. The method 500 then proceeds to step 512.

At step 512, a next consecutive segment in the main data stream can optionally be automatically presented upon completion of supplemental content. For example, referring again to FIG. 3, upon completion of the presentation of the supplemental content segment 303, content segment 104, which is the next consecutive segment in the main data stream after content segment 102, can be automatically presented to a user without any user intervention. Furthermore, the processor of decoder 412 can be configured to perform step 512. For example, the processor 414 of the decoder 412 can be configured to detect the end of the presentation of segment 303 and automatically display segment 104 upon completion of the presentation of segment 303 without any user intervention. The method 500 can then be exited.

Alternate embodiments of the present invention can include synchronizing the transmission of one or more complementary data stream with a corresponding main data stream such that the start of one of the categorized segments in the main data stream coincides with the completion of supplemental content in one or more of the complementary data streams. For example, with reference to FIG. 3, complementary data stream 306 and/or main data stream 100 can be configured such that the end of supplemental content segment 307 coincides with the beginning of content segment 110. Moreover, the main data stream can be automatically presented upon completion of the supplemental content segment without any intervention from the user. Further, in various embodiments of the present invention, the controller 408 of the present invention can be configured to synchronize the transmission of one or more complementary data stream with a corresponding main data stream such that the start of one of the categorized segments in the main data stream coincides with the completion of supplemental content in one or more of the complementary data streams. Even further, in alternate embodiments of the present invention, the processor 414 of the decoder 412 can be configured to automatically present the main data stream upon completion of the supplemental content without any user-intervention.

In accordance with another aspect of the present principles, the consecutive, categorized segments can be transmitted in the main data stream at step 502 repeatedly to synchronize the start of a next, consecutive segment in the main data stream with the completion of the corresponding supplemental content. For example, referring again to FIG. 3, a user can view segment 102 and can select stream 302 for the presentation of segment 303, which is supplemental to segment 102, as discussed above. Upon completion of the presentation of segment 303, the main data stream can be configured such that continual repetition of the transmission of the segments in the main data stream results in the concurrence between the completion of segment 303 and the beginning of segment 104. Segment 104 is the next, consecutive segment after segment 102 in the main data stream. Thus, because the completion of segment 303 and the beginning of segment 104 are synchronized through repetition of the main data stream, a viewer can seamlessly view the next, consecutive segment in the main data stream upon completion of the supplemental content in segment 303.

In yet an alternate embodiment of the present invention, the controller 408 of the coder 402 can be configured to control the main data stream generator 404 and the complimentary data stream module 406 such that consecutive, categorized segments can be transmitted in the main data stream at step 502 repeatedly to synchronize the start of a next, consecutive segment in the main data stream with the completion of the supplemental content.

Alternately, in various embodiments of the present invention, complementary data streams can include segments in the main data stream. For example, supplemental content segments within one or more complementary streams can include the content in the main data stream that they supplement. In this way the supplemental segments can be “complete” in the sense that a user can simply select a dedicated complementary data stream and view both the content in the main data stream and the supplemental content. Further, this configuration can be suitable to implement a dedicated complimentary data stream that includes all main data content and all supplemental content in succession to provide a user with an option to view all available content concerning a presentation. The dedicated complementary data stream can, as such, include a plurality of comprehensive content segments corresponding to a plurality of associated segments in the main data stream.

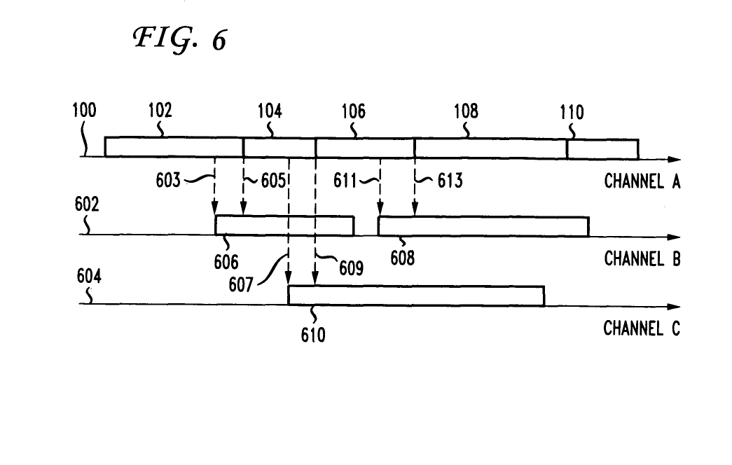

FIG. 6 depicts a representation of a main data stream and complementary data streams in accordance with an alternate embodiment of the present invention. In FIG. 6, main data stream 100 and complementary data streams 602 and 604 are transmitted and presented on channels A, B and C respectively. In addition, a prompt can be presented prior to and/or at the end of a content segment in the main data streams corresponding to crossover lines 603, 605, 607, 609, 611 and 613 such that a user can seamlessly switch to supplementary content segments 606, 608 and 610. Further, a complementary data stream can include a plurality of supplemental content segments corresponding to a plurality of main data stream content segments, as shown, for example, in data stream 602.

Having described implementations of a method, apparatus and system for providing supplemental audio/video content in a non-linear presentation (which are intended to be illustrative and not limiting), it is noted that modifications and variations can be made by persons skilled in the art in light of the above teachings. For example, although the present principles have been primarily discussed with respect to a news program, the present principles can be implemented in other types of programs such as soap operas, reality shows, quiz shows, motion pictures, sports reports, etc. Moreover, aspects of the present principles can be implemented in digital video disc players and interactive television, which can be based on Multimedia and Hypermedia Experts Group (MHEG), Motion Picture Experts Group-4 (MPEG-4), Synchronized Multimedia Integration Language (SMIL), etc. It is therefore to be understood that changes can be made in the particular implementations of the present principles disclosed which are within the scope and spirit of the invention as outlined by the appended claims. While the forgoing is directed to various implementations of the present principles, other and further implementations of the present principles can be devised without departing from the basic scope thereof.

1. A method for providing supplemental audio/video content, comprising:
transmitting a main data stream including consecutive, categorized segments of content;
transmitting with the main data stream at least one complementary data stream including content that is supplemental to at least one associated segment in the main data stream; and
prompting a user to select at least one complementary data stream during presentation of the associated segment.

2. The method of claim 1, further comprising the step of:
presenting the at least one complementary data stream in response to user-selection of the at least one complementary data stream.

3. The method of claim 1 further comprising the step of:
buffering the main data stream during presentation of the at least one complementary data stream to permit the user to seamlessly view the main data stream upon completion of the supplemental content.

4. The method of claim 3 further comprising the step of:
automatically presenting a next, consecutive segment after the associated segment in the main data stream upon completion of the supplemental content.

5. The method of claim 1, wherein the transmission of the at least one complementary data stream and the main data stream is synchronized such that the start of one of the categorized segments in the main data stream coincides with the completion of the supplemental content.

6. The method of claim 5, wherein the consecutive, categorized segments are transmitted in the main data stream repeatedly to synchronize the start of a next, consecutive segment after the associated segment in the main data stream with the completion of the supplemental content.

7. The method of claim 1, wherein the at least one complementary data stream includes the associated data segment of the main data stream.

8. The method of claim 7, wherein the at least one complementary data stream includes a plurality of comprehensive content segments corresponding to a plurality of associated segments in the main data stream.

9. A system for providing supplemental audio/video content, comprising:
a coder configured to transmit a main data stream and at least one complementary data stream; and
a decoder that is configured to receive the main data stream and the at least one complementary data stream, prompt a user to select at least one complementary data stream during presentation of an associated segment, and cause the presentation of the at least one complementary data stream in response to user-selection of the at least one complementary data stream.

10. The system of claim 9, wherein the main data stream includes consecutive, categorized segments of content and the at least one complementary data stream includes content that is supplemental to the associated segment in the main data stream.

11. The system of claim 9, wherein the decoder is further configured to buffer the main data stream in a memory during presentation of the at least one complementary data stream to permit the user to seamlessly view the main data stream upon completion of the supplemental content.

12. The system of claim 11, wherein the decoder is further configured to automatically present a next, consecutive segment after the associated segment in the main data stream upon completion of the supplemental content.

13. The system of claim 9, wherein the coder is further configured to synchronize the transmission of the at least one complementary data stream with the transmission of the main data stream such that the start of one of the categorized segments in the main data stream coincides with the completion of the supplemental content.

14. The system of claim 13, wherein the coder is further configured to transmit the consecutive, categorized segments in the main data stream repeatedly to synchronize the start of a next, consecutive segment after the associated segment in the main data stream with the completion of the supplemental content.

15. The system of claim 9, wherein the at least one complementary data stream includes the associated data segment of the main data stream.

16. The system of claim 15, wherein the at least one complementary data stream includes a plurality of comprehensive content segments corresponding to a plurality of associated segments in the main data stream.

17. The system of claim 9, wherein the main data stream and the at least one complementary data stream are broadcast on different channels.

18. An apparatus for providing supplemental audio/video content, comprising:
a main data generator configured to generate a data stream including consecutive, categorized segments;
a complementary data module configured to generate at least one complementary data stream including content that is supplemental to an associated segment in the main data stream,
wherein the apparatus is configured to transmit the main data stream and the at least one complementary data stream for presentation to a user, such that the user can be prompted to select at least one complementary data stream during presentation of the associated segment.

19. The apparatus of claim 18, further comprising:
a controller configured to synchronize the transmission of the at least one complementary data stream with the transmission of the main data stream such that the start of one of the categorized segments in the main data stream coincides with the completion of the supplemental content.

20. The apparatus of claim 19, wherein controller is further configured to transmit the consecutive, categorized segments in the main data stream repeatedly to synchronize the start of a next, consecutive segment after the associated segment in the main data stream with the completion of the supplemental content.

21. The apparatus of claim 18, wherein the at least one complementary data stream includes the associated data segment of the main data stream.

22. The apparatus of claim 21, wherein the at least one complementary data stream includes a plurality of comprehensive content segments corresponding to a plurality of associated segments in the main data stream.

23. An apparatus for providing supplemental audio/video content, comprising:
a decoder configured to receive a main data stream and at least one complementary data stream, prompt a user to select at least one complementary data stream during presentation of an associated segment of the main data stream, and cause the presentation of the at least one complementary data stream in response to user-selection of the at least one complementary data stream.
